(19) United States
(12) Patent Application Publication
(10) Pub. No.: US 2026/0200370 A1
(43) Pub. Date: Jul. 16, 2026

(54) ELECTROMECHANICAL ACTUATOR ASSEMBLY WITH MECHANICAL OVERRIDE FEATURE

(71) Applicant: B/E Aerospace, Inc., Winston-Salem, NC (US)

(72) Inventors: Pradeep Acharya, Bangalore (IN); Stephen H. Davies, Shrewsbury (GB); Sreekanth Rao, Bangalore (IN)

(21) Appl. No.: 19/445,166

(22) Filed: Jan. 9, 2026

(30) Foreign Application Priority Data
Jan. 10, 2025 (IN) 202541002430

(51) Int. Cl. B60N 2/02; B60N 2/22; B60N 2/225; F16C 1/12; F16H 19/08

(52) U.S. Cl. CPC B60N 2/02253; B60N 2/2245; B60N 2/2251; F16C 1/12; F16H 19/08

(57) ABSTRACT

An electromechanical actuator assembly (EMA) for driving one or more adjustable seat components includes a rotationally constrained ring gear and an override mechanism for use during a power failure condition to allow the ring gear to rotate to manually return the one or more adjustable components to a taxi, takeoff and landing (TTOL) compliant position. In embodiments, the override mechanism includes an internally splined pinion gear, an internally splined anti-rotation bushing, and an externally splined release pin. During a powered condition of the EMA, the externally splined release pin is engaged with the internally splined pinion gear to rotationally constrain the pinion gear and ring gear meshed with the pinion gear. During a power failure condition, the externally splined release pin can be disengaged from the pinion gear to allow the pinion gear and ring gear to be rotated.

### CROSS-REFERENCE TO RELATED AAPLICATION

This application claims the benefit of priority of Indian Patent Application Number 202541002430 filed January 10, 2025, which is hereby incorporated by reference in its entirety.

### TECHNICAL FIELD AND BACKGROUND

The present disclosure relates generally to electromechanical actuator assemblies (EMAs), and more particularly, to a mechanical override feature for EMAs for use in the event of power failure.

Business and premium class passenger seats are commonly equipped with adjustable seat components. Such components may include, but are not limited to, backrests and leg rests. In preparation for taxi, takeoff and landing (TTOL), such components are required to be positioned in a TTOL compliant position. During flight, such components may be adjusted to enhance comfort. For example, backrests may recline and leg rests may deploy.

Adjustable component motions are typically driven by electromechanical actuator assemblies (EMAs) including an electric motor coupled to a gear assembly. In use, the electric motor is energized to drive a shaft coupled to various rotationally coupled gears. During normal use, the motor is energized to rotate the shaft in a first direction to ‘deploy’ the adjustable components (e.g., recline the backrest and extend the leg rest), and rotate the shaft in a second direction to return the adjustable components to their respective TTOL positions. In the event of power failure, the electric motor may become inoperative and therefore incapable of returning ‘deployed’ adjustable components to their TTOL positions. Federal aviation safety requirements require that passenger seats be positioned in a compliant upright sitting position in preparation for TTOL. Therefore, a passenger seat locked in a reclined sitting position will not meet the requirements for TTOL and therefore may be considered unsafe.

Accordingly, what is needed is a provision for overriding an EMA in the event of power failure.

### BRIEF SUMMARY

According to one aspect, the inventive concepts according to the present disclosure are directed to an electromechanical actuator assembly (EMA) including an electric motor including an output shaft, an epicyclic gearbox including a ring gear having an inner tooth profile for transferring power from the output shaft, and an outer tooth profile, and a mechanical override mechanism. In embodiments, the mechanical override mechanism includes a pinion gear having an inner splined profile, and an outer tooth profile meshed with the outer tooth profile of the ring gear, an anti-rotation bushing interfacing with one end of the pinion gear, the anti-rotation bushing having an inner splined profile, a release pin disposed in the anti-rotation bushing, the release pin having an outer splined profile engaging the inner splined profile of the anti-rotation bushing and configured to engage the inner splined profile of the pinion gear. In a first operating mode of the EMA, the outer splined profile of the release pin is engaged with the inner splined profile of the pinion gear to rotationally constrain the pinion gear thereby rotationally constraining the ring gear, and in a second operating mode of the EMA, the release pin is axially displaced to disengage the outer splined profile of the release pin from the inner splined profile of the pinion gear to allow the pinion gear to rotate thereby allowing the ring gear to rotate.

In some embodiments, the first operating mode corresponds to a powered condition in which the electric motor is operative and the ring gear is rotationally constrained, and the second operating mode corresponds to a power failure condition in which the electric motor is inoperative and the ring gear is free to rotate.

In some embodiments, the release pin is spring loaded and biased toward the pinion gear.

In some embodiments, the assembly further includes a housing and an end cap mounted to the housing, wherein the anti-rotation bushing is mounted to the housing and the pinion gear is disposed between the end cap and the anti-rotation bushing.

In some embodiments, the assembly further includes a spring mounted on the release pin and a fastener mounted to the release pin for retaining the spring, wherein the spring is disposed between the fastener and the anti-rotation bushing such the axial movement of the release pin away from the pinion gear causes the spring to compress and energize.

In some embodiments, the assembly further includes a release lever and a cable having one end of the cable coupled to the release lever and an opposing end coupled to the release pin, wherein actuating the release lever pulls the cable thereby pulling the release pin out of engagement with the pinion gear.

In some embodiments, the inner splined profile of the pinion gear includes two more diametrically opposed spline pairs, the inner splined profile of the anti-rotation bushing includes one or more diametrically opposed spline pairs, and the outer splined profile of the release pin includes one or more diametrically opposed spline pairs.

According to another aspect, the inventive concepts according to the present disclosure are directed to a passenger seat assembly including a passenger seat including one or more adjustable components, and an EMA as described above for driving motion of the one or more adjustable components.

According to a further aspect, the inventive concepts according to the present disclosure are directed to a mechanism for controlling ring gear rotation including a pinion gear having an inner splined profile and an outer tooth profile meshed with an outer tooth profile of the ring gear, an anti-rotation bushing interfacing with one end of the pinion gear, the anti-rotation bushing having an inner splined profile, and a release pin disposed in the anti-rotation bushing, the release pin having an outer splined profile engaging the inner splined profile of the anti-rotation bushing and configured to engage the inner splined profile of the pinion gear. In embodiments, the outer splined profile of the release pin engages with the inner splined profile of the pinion gear to rotationally constrain the pinion gear thereby rotationally constraining the ring gear, and the release pin is axially displaceable to disengage the outer splined profile of the release pin from the inner splined profile of the pinion gear to allow the pinion gear to rotate thereby allowing the ring gear to rotate.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIGS. 1A and 1B are respective isometric and detailed views of an electromechanical actuator assembly (EMA) including a manual override mechanism, in accordance with example embodiments of this disclosure;

FIG. 2 is an end view showing the mechanical override mechanism engaging the ring gear, in accordance with example embodiments of this disclosure;

FIG. 3 is an exploded view of the manual override mechanism, in accordance with example embodiments of this disclosure;

FIGS. 4A-4D are various isometric views of components of the manual override mechanism, in accordance with example embodiments of this disclosure;

FIG. 5 is a fragmentary isometric view illustrating component positions of the mechanical override mechanism, in accordance with example embodiments of this disclosure;

FIGS. 6A and 6B are sectional views showing the release pin positions in the respective first and second operating modes, in accordance with example embodiments of this disclosure; and

FIGS. 7A and 7B are schematic side views of a passenger seat assembly equipped with the EMA with the mechanical override mechanism illustrating the respective upright and reclined positions of an adjustable backrest.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to an electromechanical actuator assembly (EMA) including a mechanical override mechanism. In the event of power loss, motor failure or other malfunction at the driving end of the EMA, the mechanical override mechanism may be actuated to release a ring gear that is rotationally constrained during normal use (e.g., powered and operating as intended). In the event of power failure, for example, the mechanical override mechanism can be actuated to release the ring gear allowing ‘deployed’ components to be returned to their original position.

In a particular conceived example, the EMA may be incorporated in a passenger seat such as an aircraft passenger seat to control seat component adjustability between an upright sitting position in preparation for TTOL, and a reclined position during flight. The seat component may be an adjustable back rest, adjustable leg rest, etc. In the event of power failure or malfunction, assuming one or more seat components are deployed (e.g., moved away from their TTOL position), the mechanical override mechanism may be actuated to free the ring gear rotational constraint thereby allowing the ring gear to rotate freely. In embodiments, the ring gear is part of an epicyclic gear assembly for coupling motor output shaft motion to seat component motion. Once the one or more adjustable components are returned to their TTOL compliant position, the mechanical override mechanism may be reengaged to rotationally constrain the ring gear. In embodiments, the mechanical override mechanism may be coupled to a release lever located on the seat for use by the flight crew in the event of power failure. When implemented in an aircraft passenger seat, the mechanical override mechanism satisfies the requirement for a mechanical override function.

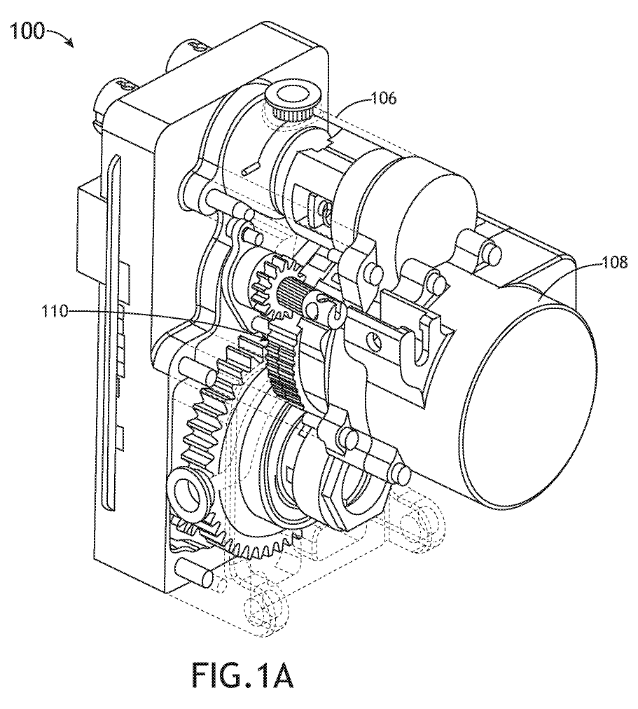

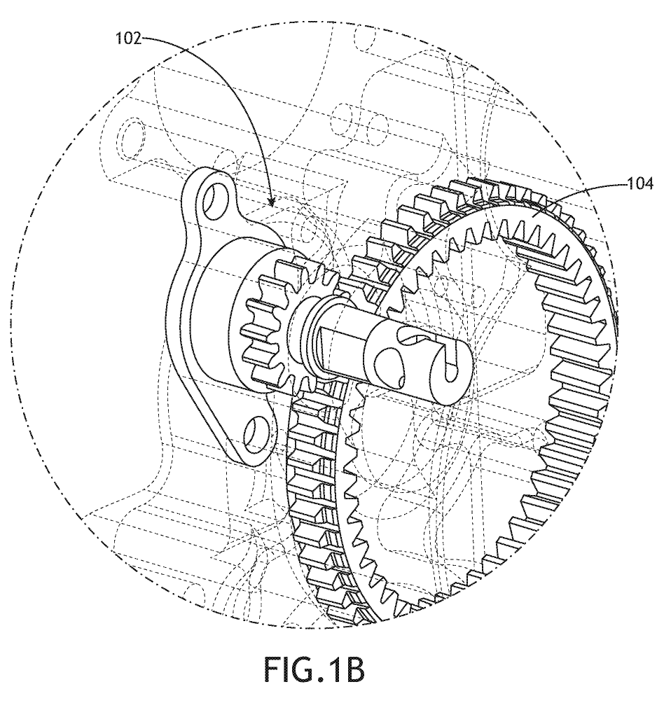

FIG. 1 illustrates an EMA 100 and mechanical override mechanism 102 for releasing a normally rotationally constrained ring gear 104 to permit the ring gear 104 to rotate freely to, for example, return a deployed seat component to a TTOL compliant position in the event of power failure, motor malfunction, etc. The EMA 100 generally includes an epicyclic gearbox including at least one ring gear 104. In embodiments, the epicyclic gearbox may be used to drive rotation of a movable seat component such as a seat back, leg rest, etc.

In embodiments, the EMA 100 may include a housing 106, an electric motor 108 driving an output shaft, at least one epicyclic gearbox 110, and at least one drive shaft for driving motion of an adjustable component. The particular configuration of the at least one epicyclic gearbox 110 is not critical and may vary. In use, the electric motor 108 operates to drive the output shaft to rotate gears of the gearbox. As shown, in a non-limiting example, the EMA 100 includes an epicyclic gearbox coupled to the motor shaft on a low torque side of the EMA 100, and a spur gearbox coupled to the shaft on a high torque side of the EMA 100. A controller including one or more processors may control the EMA 100. Gear types in the EMA 100 may include, but are not limited to, spur gears (e.g., hubbed or hubless), bevel gears, single gears, double gears, etc., each having cut teeth that are meshed with another toothed gear or component to transmit rotational power.

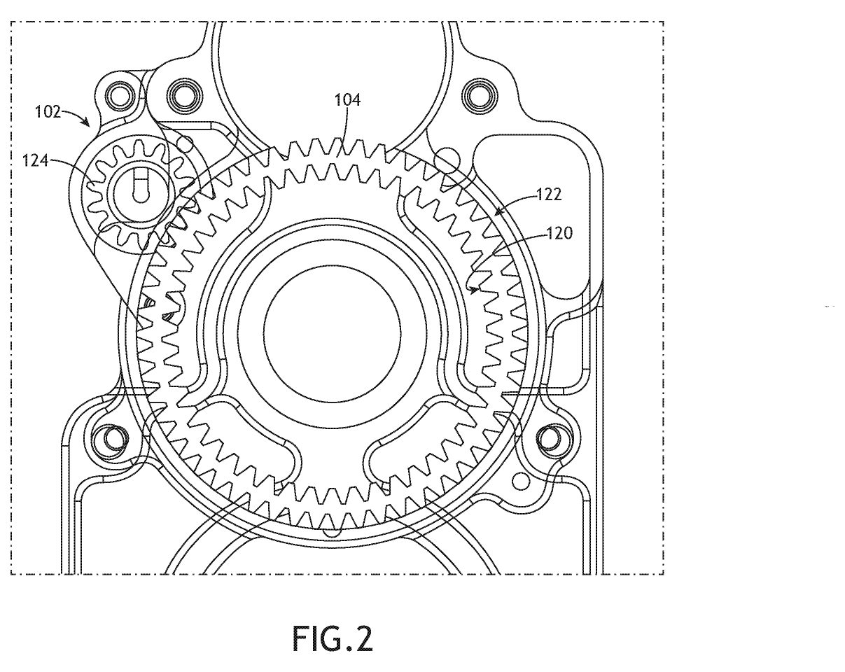

FIG. 2 illustrates the interface between the mechanical override mechanism 102 and the ring gear 104. In embodiments, the ring gear 104 includes an inner tooth profile 120 associated with the seat component driving motion, and an outer tooth profile 122 for interfacing with the mechanical override mechanism 102. In a first operating mode of the EMA 100, corresponding to a normal or standard operating mode is which the motor 108 is powered and performing as intended, the ring gear 104 is rotationally constrained by a rotationally constrained pinion gear 124 of the mechanical override mechanism 102. In a second operating mode of the EMA 100, corresponding to a power failure, etc., the pinion gear 124 is capable of being rotationally released thereby rotationally releasing the ring gear 104 allowing the ring gear 104 to rotate freely.

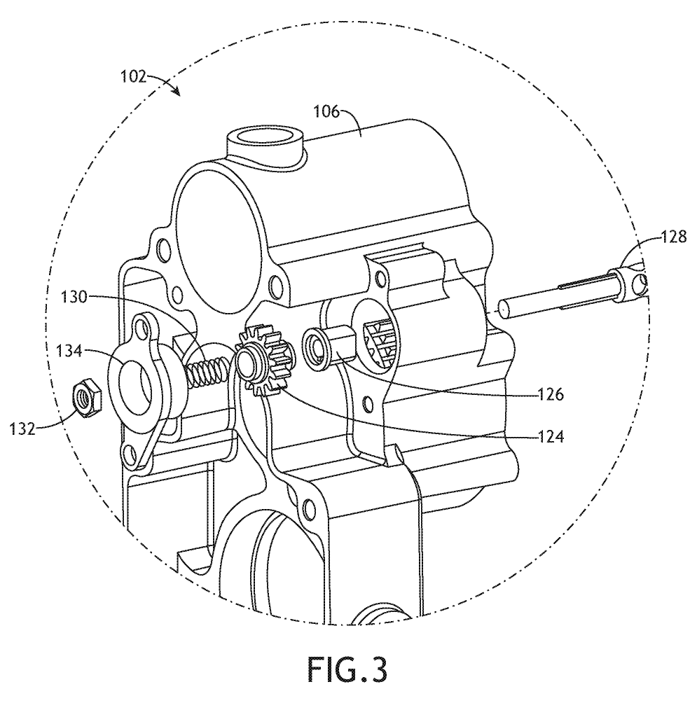

FIG. 3 illustrates the components of the mechanical override mechanism 102 according to the present disclosure. In embodiments, the mechanical override mechanism 102 includes the pinion gear 124, an anti-rotation bushing 126, and a release pin 128. In embodiments, the pinion gear 124 is rotatably mounted on oner end of the release pin 128. In embodiments, the pinion gear 124 includes an inner splined profile, the anti-rotation bushing 126 includes an inner splined profile, and the release pin 128 includes an outer splined profile. In embodiments, the anti-rotation bushing 126 is mounted to the housing 106 and rotationally constrained such that the anti-rotation bushing 126 is prevented from rotating relative to the housing 106. For example, the anti-rotation bushing 126 may include diametrically opposed chamfered sides for aligning in a specific orientation with a corresponding chamfered opening formed in the housing 106. The anti-rotation bushing 126 may be positioned at one end of the pinion gear 124, and in some embodiments interfaces with the end of the pinion gear 124.

The mechanical override mechanism 102 further includes a spring 130 mounted on the release pin 128, a fastener 132 (e.g., nut) mounted on the release pin 128 for retaining the spring 130, and an end cap 134 mounted to the housing 106. In use, the spring 130 functions to spring-load the release pin 128 such that the release pin 128 is biased toward engagement with the pinion gear 124. In use, when the release pin 128 is pulled against the force of the spring 130, the spring is compressed and energized such that, when pulling force on the release pin 128 is released, the release pin 128 returns automatically to a position engaging the pinion gear 124. In embodiments, the spring 130 is seated between the end cap 134 and the anti-rotation bushing 124 such that axial motion of the release pin 128 away from the pinion gear 124 causes the spring 130 to be compressed.

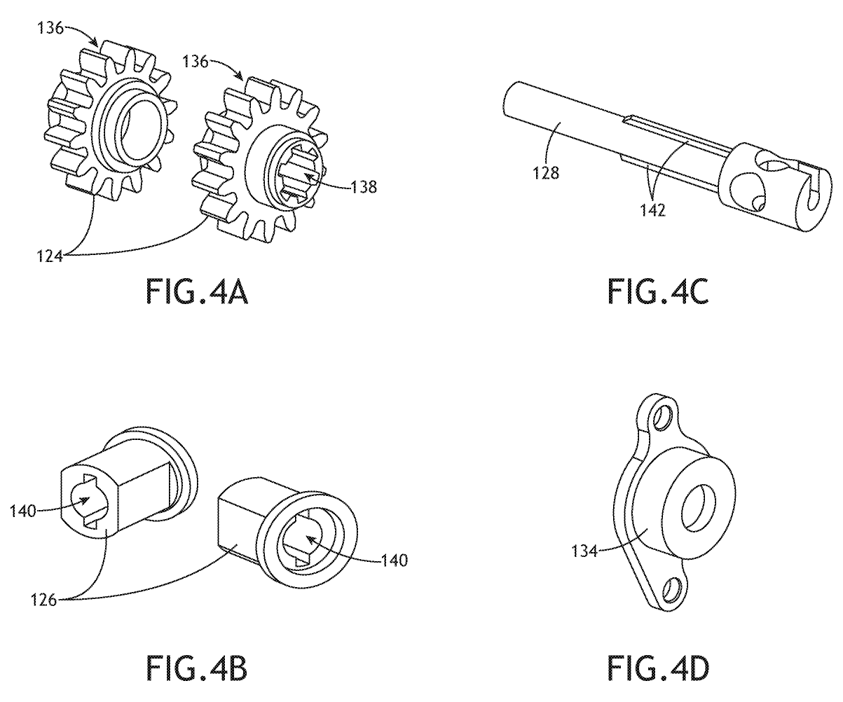

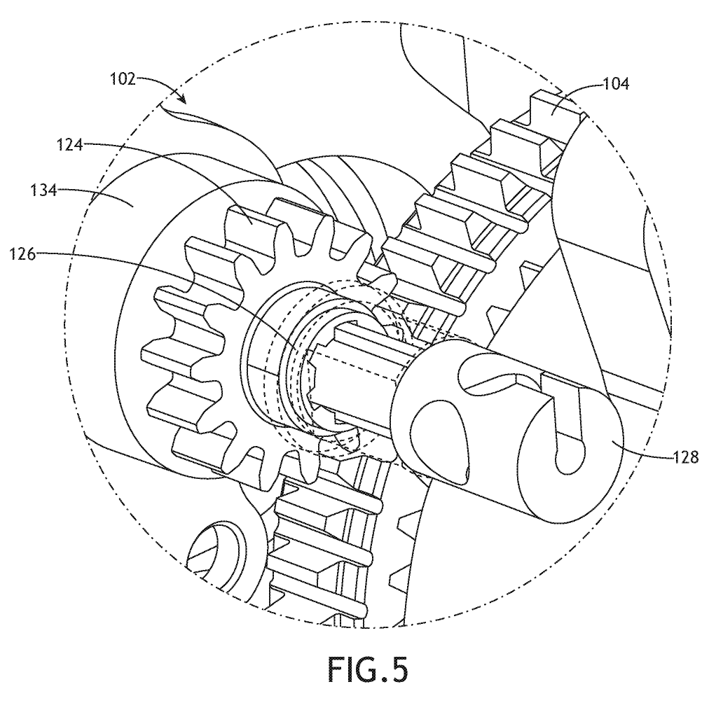

FIGS. 4A-4D illustrate components of the mechanical override mechanism 102. As shown in FIG. 4A, the pinion gear 124 has an outer tooth profile 136 and an inner splined profile 138 including two or more diametrically opposed spline pairs, for example, three or more diametrically opposed spline pairs as shown. As shown in FIG. 4B, the anti-rotation bushing 126 includes an inner splined profile 140 including one or more diametrically opposed spline pairs. As shown in FIG. 4C, the release pin 128 includes one or more diametrically opposed spline pairs 142. FIG. 5D illustrates a configuration of the end cap 134 including tabs for mounting the end cap 134 to the housing 106.

FIG. 5 illustrates the assembled state of the mechanical override mechanism 102 showing the anti-rotation bushing 124 transparent for clarity. As shown, the release pin 128 is disposed in the anti-rotation bushing 124 and rotationally constrained by the interaction of the diametrically opposed spline pair of the release pin 128 engaged with the internal spline pair of the anti-rotation bushing 124. In use, the release pin 128 translates axially. The external spline pair of the release pin 128 further engages, when in the first operating mode, with one of the internal spline pairs of the pinion gear 124. The pinion gear 124 may include a greater number of spline pairs as compared to the release pin 128 such that the alignment of the pinion gear 124 is not critical when the pinion gear 124 stops rotating. In other words, the multiple spline pairs of the pinion gear 124 allow the release pin 128 to easily locate in one of the spline pairs of the pinion gear 124 for engagement when the release pin 128 is released.

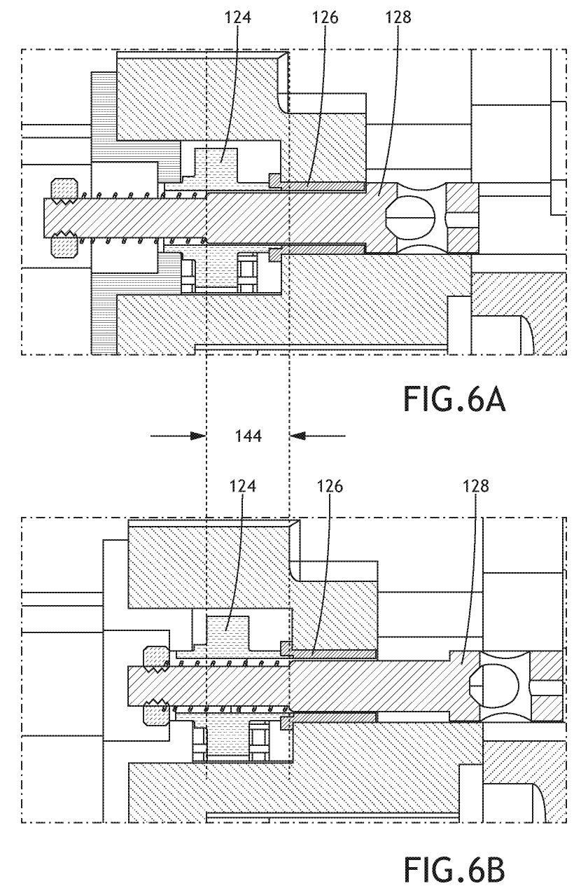

FIGS. 6A and 6B illustrate the respective first and second positions of the release pin 128 corresponding to the first and second operating modes. In FIG. 6A, the release pin 128 is shown engaging the pinion gear 124 to rotationally constrain the pinion gear 124. In other words, the release pin 128 is positioned to be rotationally constrained by the anti-rotation bushing 126 and to rotationally constrain the pinion gear 124 by interfacing with the pinion gear 124 through the spline/spline interface. In FIG. 6B, the release pin 128 is shown withdrawn (i.e., axially displaced to the right) to disengage from the pinion gear 124 thereby allowing the pinion gear 124 to rotate freely. In other words, in the second operating mode, the release pin 128 is positioned to be rotationally constrained by the anti-rotation bushing 126 yet disengaged from the pinion gear 124. FIGS. 6A and 6B further show the displacement distance 144 between the first and second positions of the release pin 128.

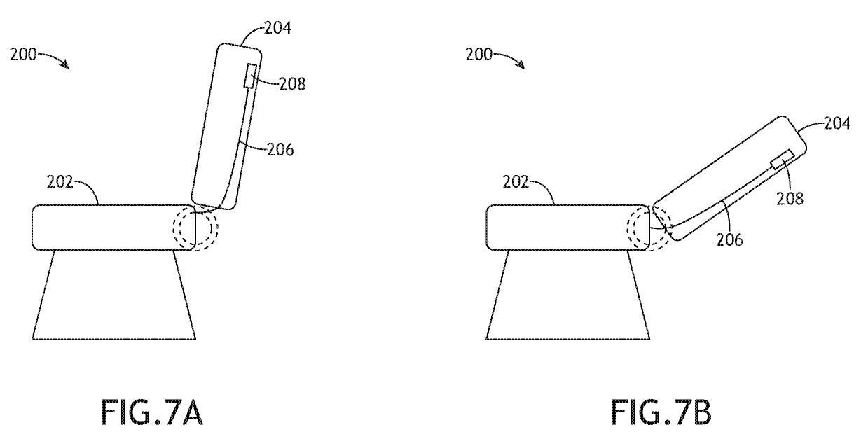

FIGS. 7A and 7B show the EMA 100 including the mechanical override mechanism 102 implemented in a passenger seat assembly 200 including one or more adjustable seat components. In embodiments, the passenger seat assembly 200 includes a passenger seat 202 including an adjustable component 204, for instance a seat back, movable between an upright sitting position as shown in FIG. 7A, and a reclined sitting position as shown in FIG. 7B. The adjustable component could also be a leg rest movable between a stowed position and a deployed position, or another adjustable seat component. In embodiments, the release pin 128 of the mechanical override mechanism 102 is coupled to one end of a cable 206, for instance a Bowden cable, coupled at the opposing end to a lever 208 located on the passenger seat 202.

In use, the lever 208 may be actuated to pull the cable 206 to translate the cable to pull the release pin 128 to displace the release pin 130 to allow the pinion gear 124 to rotate thereby allowing the gear ring 104 to be rotated. When the lever 208 is released, the return force of the compression spring 130 causes the release pin 128 to reengage the pinion gear 124 automatically thereby constraining rotation of the pinion gear 124 and the ring gear 104 meshed with the pinion gear 104. In the event of motor failure, the override mechanism can be used to manually adjust the adjusted component to its TTOL position. The lever 208 may be discretely positioned on the passenger seat 202, for instance under the seat bottom or on the back of the seat back, for use by the flight crew but substantially concealed from the view of the passenger. While the manual override mechanism has been described in the context of a seat recline mechanism, the override mechanism can be utilized with any gear assembly benefitting from such an override mechanism.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. An electromechanical actuator assembly (EMA), comprising:
an electric motor including an output shaft;
an epicyclic gearbox including a ring gear having an inner tooth profile for transferring power from the output shaft, and an outer tooth profile; and
a mechanical override mechanism, comprising:
a pinion gear having an inner splined profile, and an outer tooth profile meshed with the outer tooth profile of the ring gear;
an anti-rotation bushing interfacing with one end of the pinion gear, the anti-rotation bushing having an inner splined profile; and
a release pin disposed in the anti-rotation bushing, the release pin having an outer splined profile engaging the inner splined profile of the anti-rotation bushing and configured to engage the inner splined profile of the pinion gear;
wherein:
in a first operating mode of the EMA, the outer splined profile of the release pin is engaged with the inner splined profile of the pinion gear to rotationally constrain the pinion gear thereby rotationally constraining the ring gear; and
in a second operating mode of the EMA, the release pin is axially displaced to disengage the outer splined profile of the release pin from the inner splined profile of the pinion gear to allow the pinion gear to rotate thereby allowing the ring gear to rotate.

2. The EMA of claim 1, wherein the first operating mode corresponds to a powered condition in which the electric motor is operative and the ring gear is rotationally constrained, and the second operating mode corresponds to a power failure condition in which the electric motor is inoperative and the ring gear is free to rotate.

3. The EMA of claim 1, wherein the release pin is spring loaded and biased toward the pinion gear.

4. The EMA of claim 1, further comprising:
a housing; and
an end cap mounted to the housing;
wherein the anti-rotation bushing is mounted to the housing and the pinion gear is disposed between the end cap and the anti-rotation bushing.

5. The EMA of claim 4, further comprising:
a spring mounted on the release pin; and
a fastener mounted to the release pin for retaining the spring;
wherein the spring is disposed between the fastener and the anti-rotation bushing such the axial movement of the release pin away from the pinion gear causes the spring to compress and energize.

6. The EMA of claim 1, further comprising:
a release lever; and
a cable, wherein one end of the cable is coupled to the release lever and an opposing end of the cable is coupled to the release pin;
wherein actuating the release lever pulls the cable thereby pulling the release pin out of engagement with the pinion gear.

7. The EMA of claim 1, wherein:
the inner splined profile of the pinion gear includes two more diametrically opposed spline pairs;
the inner splined profile of the anti-rotation bushing includes one or more diametrically opposed spline pairs; and
the outer splined profile of the release pin includes one or more diametrically opposed spline pairs.

8. A passenger seat assembly, comprising:
a passenger seat including one or more adjustable components; and
an electromechanical actuator assembly (EMA) for driving motion of the one or more adjustable components, the EMA comprising:
an electric motor including an output shaft;
an epicyclic gearbox including a ring gear having an inner tooth profile for transferring power from the output shaft, and an outer tooth profile; and
a mechanical override mechanism, comprising:
a pinion gear having an inner splined profile, and an outer tooth profile meshed with the outer tooth profile of the ring gear;
an anti-rotation bushing disposed at one end of the pinion gear, the anti-rotation bushing having an inner splined profile; and
a release pin disposed in the anti-rotation bushing, the release pin having an outer splined profile engaging the inner splined profile of the anti-rotation bushing and configured to engage the inner splined profile of the pinion gear;
wherein:
in a first operating mode of the EMA, the outer splined profile of the release pin is engaged with the inner splined profile of the pinion gear to rotationally constrain the pinion gear thereby rotationally constraining the ring gear; and
in a second operating mode of the EMA, the release pin is axially displaced to disengage the outer splined profile of the release pin from the inner splined profile of the pinion gear to allow the pinion gear to rotate thereby allowing the ring gear to rotate.

9. The passenger seat assembly of claim 8, wherein the first operating mode corresponds to a powered condition in which the electric motor is operative and the ring gear is rotationally constrained, and the second operating mode corresponds to a power failure condition in which the electric motor is inoperative and the ring gear is free to rotate.

10. The passenger seat assembly of claim 8, wherein the release pin is spring loaded and biased toward the pinion gear.

11. The passenger seat assembly of claim 8, wherein the EMA further comprises:
a housing; and
an end cap mounted to the housing;
wherein the anti-rotation bushing is mounted to the housing and the pinion gear is disposed between the end cap and the anti-rotation bushing.

12. The passenger seat assembly of claim 11, wherein the EMA further comprises:
a spring mounted on the release pin; and
a fastener mounted to the release pin for retaining the spring;
wherein the spring is disposed between the fastener and the anti-rotation bushing such the axial movement of the release pin away from the pinion gear causes the spring to compress and energize.

13. The passenger seat assembly of claim 8, further comprising:
a release lever mounted to the passenger seat; and
a cable, wherein one end of the cable is coupled to the release lever and an opposing end of the cable is coupled to the release pin;
wherein actuating the release lever pulls the cable thereby pulling the release pin out of engagement with the pinion gear.

14. The passenger seat assembly of claim 13, wherein the release lever is mounted under a seat bottom of the passenger seat.

15. The passenger seat assembly of claim 8, wherein:
the inner splined profile of the pinion gear includes two more diametrically opposed spline pairs;
the inner splined profile of the anti-rotation bushing includes one or more diametrically opposed spline pairs; and
the outer splined profile of the release pin includes one or more diametrically opposed spline pairs.

16. A mechanism for controlling ring gear rotation, comprising:
a pinion gear having an inner splined profile, and an outer tooth profile meshed with an outer tooth profile of the ring gear;
an anti-rotation bushing interfacing with one end of the pinion gear, the anti-rotation bushing having an inner splined profile; and
a release pin disposed in the anti-rotation bushing, the release pin having an outer splined profile engaging the inner splined profile of the anti-rotation bushing and configured to engage the inner splined profile of the pinion gear;
wherein:
the outer splined profile of the release pin engages with the inner splined profile of the pinion gear to rotationally constrain the pinion gear thereby rotationally constraining the ring gear; and
the release pin is axially displaceable to disengage the outer splined profile of the release pin from the inner splined profile of the pinion gear to allow the pinion gear to rotate thereby allowing the ring gear to rotate.

17. The mechanism of claim 16, wherein the release pin is spring loaded and biased toward the pinion gear.

18. The mechanism of claim 16, further comprising:
a housing; and
an end cap mounted to the housing;
wherein the anti-rotation bushing is mounted to the housing and the pinion gear is disposed between the end cap and the anti-rotation bushing.

19. The mechanism of claim 18, further comprising:
a spring mounted on the release pin; and
a fastener mounted to the release pin for retaining the spring;
wherein the spring is disposed between the fastener and the anti-rotation bushing such the axial movement of the release pin away from the pinion gear causes the spring to compress and energize.

20. The mechanism of claim 16, further comprising:
a release lever; and
a cable, wherein one end of the cable is coupled to the release lever and an opposing end of the cable is coupled to the release pin;
wherein actuating the release lever pulls the cable thereby pulling the release pin out of engagement with the pinion gear.
